(19) United States
(12) Patent Application Publication
(10) Pub. No.: US 2014/0352580 A1
(43) Pub. Date: Dec. 4, 2014

(54) SAFETY DEPOSIT COMPARTMENT WITH BIOMETRIC SENSOR

(71) Applicant: Julie Stradiota, Newcastle, CA (US)

(72) Inventor: Julie Stradiota, Newcastle, CA (US)

(21) Appl. No.: 14/461,219

(22) Filed: Aug. 15, 2014

Related U.S. Application Data
(63) Continuation of application No. 12/883,416, filed on Sep. 16, 2010.

(51) Int. Cl. E05G 1/04; E05B 65/00; E05B 37/00; G07C 9/00; G06K 9/00

(52) U.S. Cl. CPC E05G 1/04; G07C 9/00158; G06K 9/00013; E05B 37/0031; E05B 65/0075
USPC 109/23

(57) ABSTRACT

A personally accessible storage unit includes a support structure, which is configured to house a safety deposit compartment slidably mounted within the support structure. The safety deposit compartment has a bottom surface and a plurality of surrounding side walls defining a storage area for a valuable article. A command panel is mounted on the exterior surface of the support structure and includes a biometric fingerprint scanner programmed to recognize the fingerprints of a user. A latch mechanism attached to the interior surface of the support structure is in communication with the fingerprint scanner and is engageable with the safety deposit compartment, based on input from the command panel. The unit also has means for providing electrical power to the command panel and the latch mechanism, which may include an electrical cord and plug and/or a battery. A storage unit having a hinged access panel is also provided.

### CROSS-REFERENCE TO RELATED APPLICATION

This application is a Continuation of U.S. patent application Ser. No. 12/883,416, filed Sep. 16, 2010, the disclosure of which is hereby incorporated by reference in its entirety.

### TECHNICAL FIELD

This application relates generally to the field of safety deposit compartments and, more specifically, to the safety deposit compartments having access limited by a biometric fingerprint scanner. In one version, the safety deposit compartment is a drawer of a nightstand or a filing cabinet. In other versions, the safety deposit compartment is part of a vehicle console or glove compartment. In yet another version, the safety deposit compartment is a portable unit.

### BACKGROUND

To protect items of value in a home, individuals have historically hidden the items in their house. Many times, the items are hidden in a dresser drawer or nightstand in the bedroom of the item's owner. Obviously, while convenient, hiding an object alone does little to secure it from theft or unwanted use.

Other homeowners have relied on a home safe or lockbox. Traditionally, home safes may be provided with a key or a combination lock, which are kept by the owner of the safe. The home safes themselves are usually kept in a closet in a bedroom or foyer, both for privacy and because traditional safes have a bulky, generally unattractive appearance.

One particular type of home safe is a gun safe or gun cabinet. A gun safe may be used by a gun owner as a storage location for his firearms and accompanying gear, such as ammunition and cleaning instruments. Gun safes provide an important role in maintaining the security of a firearm by limiting its availability to those unsuited for using the firearm, such as children or those without proper training. Because gun safes are generally intended to store several large weapons, such as rifles and shotguns, these cabinets are correspondingly large and difficult to conceal.

Furthermore, a homeowner having a single handgun is unlikely to purchase a large gun safe, as the size and expense of a large safe does not correspond to the size of the firearm intended to be secured. Nevertheless, a homeowner having a handgun or other small firearm may desire a secure location in which the gun may be securely stowed and from which the gun may be quickly retrieved if needed.

What is needed in the industry is a safety deposit compartment, which may be used to secure a small firearm or other valuable possession, in a decorative housing, such as a piece of furniture.

In addition to their bulky appearance, traditional safes and gun safes alike suffer from a potential shortcoming associated with their locking mechanisms. If the owner of the safe loses the key or forgets the combination, the safe becomes inaccessible without the services of a locksmith or professional safecracker. Employing the services of one of these professionals is time-consuming, inconvenient, and expensive, especially since the safe itself is often destroyed to gain entry. Moreover, in the case of a sudden and unlawful entry by a criminal into a person's home, the homeowner may be separated from the key to his safe or may become too emotionally taxed to successfully remember the safe combination or to manipulate the safe dial.

Thus, another need in the industry is for a safety deposit compartment with a more convenient opening mechanism. Specifically, what is needed is a safety deposit compartment that requires no key and that requires no manipulation of a dial in a series of numbers, like that used in a traditional three-number combination lock. A locking mechanism using a biometric fingerprint scanner addresses these issues by allowing the user to simply bring his finger into contact with the scanner, thereby quickly gaining entry into his safety deposit compartment.

Finally, as mentioned above, traditional safes suffer from the drawback that they are bulky and heavy. Another need in the industry is for a safety deposit compartment that is portable.

### SUMMARY

A personally accessible storage unit includes a support structure, which is configured to house a safety deposit compartment slidably mounted within the support structure. The safety deposit compartment has a bottom surface and a plurality of surrounding side walls defining a storage area for a valuable article. A command panel is mounted on the exterior surface of the support structure and includes a biometric fingerprint scanner programmed to recognize the fingerprints of a user. A latch mechanism attached to the interior surface of the support structure is in communication with the fingerprint scanner and is engageable with the safety deposit compartment, based on input from the command panel. The unit also has means for providing electrical power to the command panel and the latch mechanism, which may include an electrical cord and plug and/or a battery.

According to this aspect, the support structure may be one of a nightstand, a filing cabinet, a desk, and a portable housing.

Further in this aspect, the support structure may be a nightstand having a plurality of drawers.

Also in this aspect, the article being stored may be at least one of a handgun, a weapon, a piece of jewelry, a passport, a will, a vital record, and an another object of importance to the user thereof.

According to another aspect, a personally accessible storage unit is provided with a safety deposit compartment having a bottom surface and a plurality of surrounding side walls defining a storage area for receipt and storage of a valuable article. The safety deposit compartment further includes a hinged panel defining entrance to the storage area. A command panel is mounted on the exterior surface of the safety deposit compartment and includes a biometric fingerprint scanner programmed to recognize the fingerprints of a user of the unit. A latch mechanism is attached to the interior surface of the safety deposit compartment. The latch mechanism is in communication with the command panel and is engageable with the hinged panel, based on input from the command panel. The unit also includes a means for providing electrical power to the command panel and the latch mechanism.

In this aspect, the safety deposit compartment may be one of an automobile console unit and a glove compartment of an automobile. Further in this aspect, electrical power may be provided by way of the wiring of the automobile or a battery.

### BRIEF DESCRIPTION OF THE DRAWINGS

The drawings, when considered in connection with the following description, are presented for the purpose of facilitating an understanding of the subject matter sought to be protected.

FIG. 1A is a side perspective view of a personally accessible storage unit with a safety deposit compartment, according to a first aspect provided herein in which the unit is a nightstand;

FIG. 1B is a front perspective view of a second personally accessible storage unit with a safety deposit compartment, according to another aspect provided herein in which the unit is an alternate nightstand;

FIG. 2 is a plan elevational view of an exemplary control panel as used with the personally accessible storage units of the present disclosure;

FIG. 3 is an enlarged perspective view of the slidable safety deposit compartment, as mounted in the unit of FIG. 1A or 1B;

FIG. 4 is a plan elevational view of a latch mechanism used in concert with the storage units of the present disclosure;

FIG. 5 is a front perspective view of a third personally accessible storage unit with a safety deposit compartment, according to another aspect provided herein in which the unit is a filing cabinet;

FIG. 6 is a front perspective view of a fourth personally accessible storage unit with a safety deposit compartment, according to another aspect provided herein in which the unit is a desk;

FIG. 7 is a front perspective view of a fifth personally accessible storage unit with a safety deposit compartment, according to yet another aspect provided herein in which the unit is a portable housing; and

FIG. 8 is a side perspective view of a sixth personally accessible storage unit with a safety deposit compartment, according to a further aspect provided herein in which the unit is an automobile console.

### DETAILED DESCRIPTION

Reference is now made to the drawings for illustration of various components of the present personally accessible storage units. While the particular illustrations provided herein are directed to various support structures for holding the safety deposit compartments, many elements and embodiments are equally applicable to creating storage units from other support structures. Moreover, while a particular command panel has been shown and described, other types of command panels or command panels having different features may instead be used. In addition, any of the storage units may be electrically powered using conventional electrical cords and plugs or battery power or a combination of both.

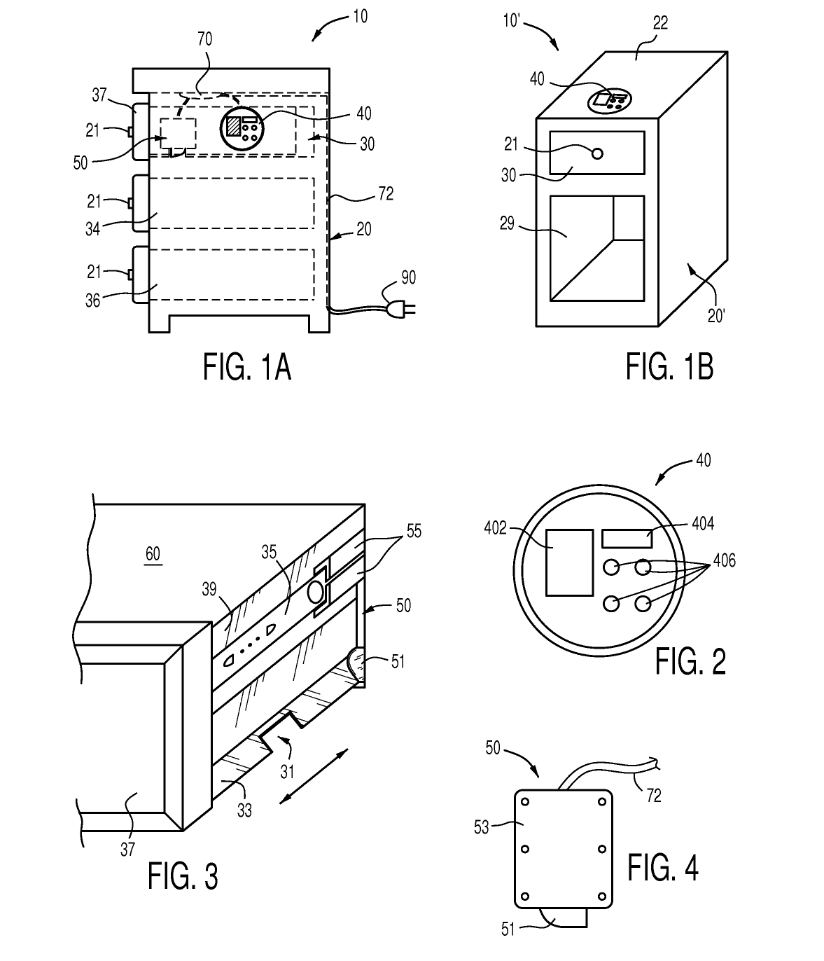

Turning now to FIG. 1A, a personally accessible storage unit 10 is provided in which a support structure 20 is a traditional, multi-drawer nightstand. The support structure 20 includes a top drawer 30, a middle drawer 34, and a bottom drawer 36. As shown, the top drawer 30 functions as a safety deposit compartment, although one or more of the other drawers may perform this function. As a non-limiting example, the other drawers that do not function as a safety deposit compartment may function as a normal drawers. For convenience, each drawer 30, 34, 36 may be provided with a drawer pull 21, such as a knob or handle. By way of reference, the safety deposit compartment 30 may be provided with a face panel 37 matching those of the other drawers 34, 36, such that a casual observation of the nightstand 20 would not reveal additional functionality of the unit 10.

As a non-limiting example, the top drawer 30 may be spring loaded where one could glide their finger and the top drawer 30 may open by itself.

A command panel 40 having a biometric fingerprint scanner (402, as in FIG. 2) may be provided, as shown, on an exterior side surface of the support structure 20. In practice, the command panel 40 may be located on a side of the nightstand 20 that will be adjacent a bed for greater privacy.

Within the interior of the support structure 20, a latch mechanism 50 may be mounted at a location near the face panel 37 of the safety deposit compartment 30. The latch mechanism 50 is actuated by a circuit board 70, which processes instructions from the command panel 40. Two latch mechanisms 50, located on opposite sides of the safety deposit compartment, may be used, if desired, for even greater security. The command panel 40 and the circuit board 70 are in electrical communication, via wiring 72, to an electrical plug 90 that is plugged into a standard household electrical outlet. Alternately, or in addition, the unit 10 may be provided with a battery 88 for power or back-up power (as shown in FIG. 7). A single 9-volt battery has been found sufficient for this purpose, although other sizes and numbers of batteries may be employed instead.

FIG. 1B illustrates a storage unit 10′ in which the support structure 20′ is a nightstand having a single drawer that functions as the safety deposit compartment 30. An open storage area 29 is provided beneath the compartment 30, which may permit ease of access to a battery (88, not shown) positioned below the compartment 30, if so desired. In this illustration, the uppermost exterior surface 22 of the support structure 20′ is provided with the command panel 40, although the panel 40 may be located elsewhere as needs or preferences dictate.

An exemplary command panel 40 is shown in FIG. 2. The command panel 40 has a fingerprint scanner 402, which may be programmed to receive the fingerprints of multiple users of the personally accessible storage units described herein. The user scans his fingerprint into the memory of the command panel and, when the user rescans his fingerprint by bringing it into contact with the fingerprint scanner 402, the command panel 40 activates the latch mechanism 50. The command panel 40 is capable of storing, scanning, and matching up to thirty fingerprints.

As another non-limiting example, a button may be pressed to turn on the personally accessible storage unit 10 then after a fingerprint could be scanned.

The command panel 40 may also be provided with a display screen 404 on which instructions, input, or other information (such as battery life) may be displayed. The command panel 40 may further include a plurality of depressible buttons 406, which may represent numbers for a numerical code entry and/or certain functions to be performed (such as input fingerprint, lock compartment, and unlock compartment). Thus, the command panel 40 is able to receive a key code pre-set to engage and disengage the latch mechanism.

The slidable safety deposit compartment 30 includes a slide mechanism 35 mounted to opposite side walls 39 of the compartment 30. The side walls 39 define a storage area 60 for receipt of an article or item of value to the user, such as a handgun, a weapon, a piece of jewelry, a passport, a will, a vital record, and an another object of importance to the user. As described above, the safety deposit compartment 30 may be provided with a face panel 37 that is decorative and that matches the face panels of the other drawers, thereby disguising the safety deposit compartment 30.

Mounted to the interior surface of the support structure 20 are slide mounts 55 that engage the slide mechanism 35 of the safety deposit compartment 30. Latch mechanisms 50 are also attached to the interior surfaces of the support structure 20 for engagement with a notch 31 in an interlock segment 33 extending from the bottom surface of the safety deposit compartment 30. The opposite sides of the safety deposit compartment 30 are provided with the interlock segments 33 in which the notch 31 is positioned for engagement with a respective latch 51 extending from the latch mechanism 50 (as shown in more detail in FIG. 4).

As a non-limiting example, the personally accessible storage unit 10 may be self-locking. The user would close the top drawer 30 and it would lock automatically.

Turning now to FIG. 4, the latch mechanism 50 includes a generally flat mounting plate 53 by which the latch mechanism is mounted to the interior surfaces of the support structure 20. The latch 51 moves in an arcuate path from the bottom of the mounting plate 53 into (and out of) contact with the notch 31 in the interlock segments 33. When engaged, the latch 51 prevents the safety deposit compartment 30 from being opened, thereby securing the contents of the compartment 30. The latch mechanism 50 is wired (e.g., using electrical wires 72) to the circuit board 70, which conveys instructions from the command panel 40.

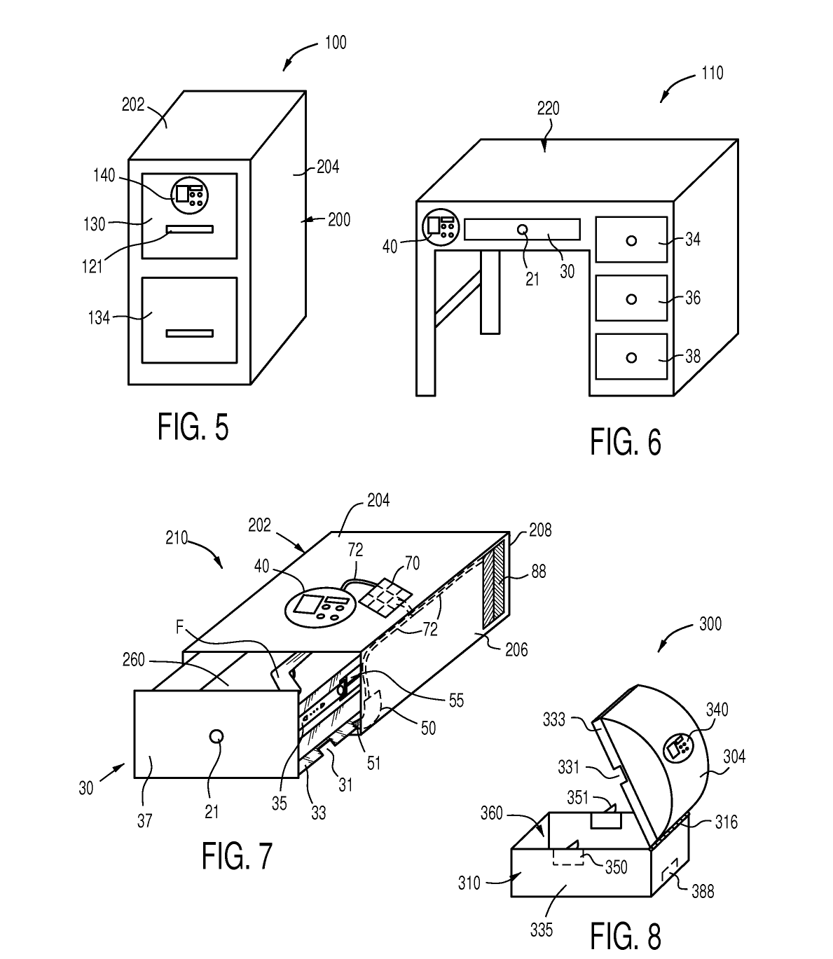

FIG. 5 illustrates a personally accessible storage unit 100 in which the support structure 200 is a filing cabinet. The filing cabinet 200 has a traditional construction with an uppermost surface 202, vertical side walls 204, and drawer pulls or handles 121. As shown, the command panel 140 is mounted on the face surface of one of the drawers, thereby creating a safety deposit compartment 130. Alternately, the command panel 140 may be mounted on one of the vertical side walls 204 or the uppermost surface 202.

In one variation, both drawers 130, 134 may be turned into safety deposit compartments by outfitting the drawers 130, 134 with interlock members (e.g., members 33 shown in FIG. 3) and by installing latch mechanisms (e.g., 50) on the interior surfaces of the support structure 200. As in the previous embodiment, the wiring (72) extends between the command panel 140, the circuit board (not shown), and the latch mechanisms (50), so that commands are conveyed to both sets of latch mechanisms 50 simultaneously.

Similarly, a storage unit 110 made from a desk 220 is shown in FIG. 6. The desk 220 may be provided with a number of drawers 30, 34, 36, 38, at least one of which is configured to function as a safety deposit compartments 30. If desired, all of the drawers 30, 34, 36, 38 may be linked to the same command panel 40 for simultaneous activation. In this illustration, the command panel 40 is located adjacent the safety deposit compartment 30, although other positions (such as those described previously) may instead be used.

In FIG. 7, the storage unit 210 includes a portable housing 202 having an uppermost surface 204, side surfaces 206, a bottom surface 208, and a slidable safety deposit compartment 30 that extends from opposite the bottom surface 208. The safety deposit compartment 30 has a bottom surface, a plurality of vertically oriented side walls 35, and a face surface 37 with a pull 21, in the form of a knob or handle. The bottom surface and the side walls 35 define a storage area 260 within which a valuable item, such as a firearm F, may be secured.

The command panel 40, in this exemplary arrangement, is located on the uppermost surface 204 of the portable housing 202. The command panel 40 is connected, via wiring 72, to a circuit board 70 (shown in phantom). The circuit board 70, in turn, is connected to the latch mechanisms 50 from which the latches 51 extend to engage the notches 31 in the interlock segments 33 of the safety deposit compartment 30. The wiring 72 also extends to a battery 88, which may be housed within the bottom surface 208 of the housing 202. For instance, the bottom surface 208 may be provided with a removable cover (not shown) for accessing the battery 88. The cover may include a snap-fit connection and/or may be held in place with one or more small screws.

Because the storage unit 210 is portable and wholly self-contained, a user may transport the storage unit 210 with him when he travels. Alternately, the storage unit 210 may be treated like a conventional safe and may be hidden from view within the user's home.

Yet another variation of the present storage units is shown in FIG. 8, in which a storage unit 300 having a hinged panel 304 is provided. In this aspect, a safety deposit compartment 310 is formed within an automobile or vehicle interior console. The unit 300 may include a bottom surface surrounded by vertically oriented side walls 335 to define a storage area 360. On oppositely disposed side walls 335 a latch mechanism 350 may be installed, such that the latch components 351 extend in an upward (or outward) direction to engage corresponding notches 331 on interlock segments 333 attached to the hinged panel 304.

The hinged panel 304 may include a padded upper surface for the comfort of the user, within which a command panel 340 may be installed. The panel 304 may rotate about a hinge 316, as is common with automotive consoles. A battery 388 may be installed within the compartment 310, or the unit 300 may be connected to the vehicle's existing electrical system.

Although a storage unit 300 is shown as being housed within a vehicle console, it should be understood that the unit 300 is equally adaptable for installation within a glove compartment, trunk, or other storage area within a vehicle.

Another embodiment provides the storage unit 210, 300 to be self-contained within the support structure 20. As such, even if the support structure 20 is destroyed, the storage unit 210, 300 still remains protected.

The preceding discussion merely illustrates the principles of the present personally accessible storage units. It will thus be appreciated that those skilled in the art may be able to devise various arrangements, which, although not specifically shown or described herein, embody the principles of the invention and are included within its spirit and scope. Furthermore, all examples are conditional language recited herein are principally intended for educational purposes and to aid the reader in understanding the principles of the invention and the concepts contributed by the inventor to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire description of the invention. The foregoing description provides a teaching of the subject matter of the appended claims, including the best mode known at the time of filing, but is in no way intended to preclude foreseeable variations contemplated by those of skill in the art.

What is claimed is:

1. A personally accessible storage unit for securely housing a valuable article, the storage unit comprising:
a support structure with an exterior surface, an interior surface, and a base, the support structure configured to house a safety deposit compartment;
a safety deposit compartment slidably mounted within the support structure, the safety deposit compartment having a bottom surface and a plurality of surrounding side walls defining a storage area for receipt and storage of the valuable article;
a command panel mounted on the exterior surface of the support structure, the command panel comprising a biometric fingerprint scanner programmed to recognize the fingerprints of a user of the unit;
a latch mechanism attached to the interior surface of the support structure, the latch mechanism being engageable with the safety deposit compartment and being in communication with the fingerprint scanner, such that the latch mechanism is engaged and disengaged based on input from the command panel; and
a means for providing electrical power to the command panel and the latch mechanism.

2. The storage unit of claim 1, wherein the support structure is selected from the group consisting of a nightstand, a filing cabinet, a desk, and a portable housing.

3. The storage unit of claim 2, wherein the support structure is a nightstand having a plurality of drawers.

4. The storage unit of claim 1, wherein the safety deposit compartment further comprises a face panel, and the face panel further comprises a drawer pull.

5. The storage unit of claim 4, wherein the control panel is attached to the face panel of the safety deposit compartment.

6. The storage unit of claim 4, wherein the bottom panel of the safety deposit compartment has an interlock segment projecting therefrom, the interlock segment being positioned between the side walls of the safety deposit compartment and the interior surface of the support structure and defining a notch therethrough for engagement with the latch mechanism.

7. The storage unit of claim 6, wherein the notch in the interlock segment is proximate the face panel of the safety deposit compartment.

8. The storage unit of claim 6, wherein opposite sides of the safety deposit compartment are provided with the interlock segment, and wherein opposite interior surfaces of the support structure are provided with the corresponding latch mechanism, such that a pair of latch mechanisms engage a pair of interlock segments to secure the safety deposit compartment.

9. The storage unit of claim 1, wherein the control panel is attached to an uppermost exterior surface of the support structure.

10. The storage unit of claim 1, wherein the control panel is attached to a side exterior surface of the support structure.

11. The storage unit of claim 1, wherein the control panel is configured to store, scan, and match up to thirty fingerprints and is further configured to receive a key code pre-set to engage and disengage the latch mechanism.

12. The storage unit of claim 1, wherein the means for providing electrical power is at least one of an electrical cord and a plug plugged into a standard electrical power outlet and a battery.

13. The storage unit of claim 11, wherein the battery is a 9-volt battery.

14. The storage unit of claim 1, wherein the article being stored is at least one of a handgun, a weapon, a piece of jewelry, a passport, a will, a vital record, and an another object of importance to the user thereof.

15. A personally accessible storage unit for securely housing a valuable article, the storage unit comprising:
a safety deposit compartment having a bottom surface and a plurality of surrounding side walls defining a storage area for receipt and storage of the valuable article, the safety deposit compartment further having a hinged panel defining entrance to the storage area;
a command panel mounted on the exterior surface of the safety deposit compartment, the command panel comprising a biometric fingerprint scanner programmed to recognize the fingerprints of a user of the unit;
a latch mechanism attached to the interior surface of the safety deposit compartment, the latch mechanism being engageable with the hinged panel and being in communication with the fingerprint scanner, such that the latch mechanism is engaged and disengaged based on input from the command panel; and
a means for providing electrical power to the command panel and the latch mechanism.

16. The storage unit of claim 15, wherein the safety deposit compartment comprises an automobile console unit or a glove compartment of an automobile.

17. The storage unit of claim 16, wherein the means for providing electrical power comprises at least one of wiring into an electrical system of the automobile and a battery.

18. The storage unit of claim 15, wherein opposite sides of the hinged panel are provided with an interlock segment defining a notch therethrough, and wherein opposite interior surfaces of the safety deposit compartment are provided with the corresponding latch mechanism, such that a pair of latch mechanisms engage a pair of interlock segments to secure the safety deposit compartment.

19. The storage unit of claim 18, wherein opposite sides of the safety deposit compartment are provided with an interlock segment defining a notch therethrough, and wherein opposite interior surfaces of the hinged panel are provided with the corresponding latch mechanism, such that a pair of latch mechanisms engage a pair of interlock segments to secure the safety deposit compartment.

20. The storage unit of claim 15, wherein the control panel is configured to store, scan, and match up to thirty fingerprints and is further configured to receive a key code pre-set to engage and disengage the latch mechanism.
